(19) United States
(12) Patent Application Publication
(10) Pub. No.: US 2025/0071136 A1
(43) Pub. Date: Feb. 27, 2025

(54) METHODS AND SYSTEMS FOR DETECTING MALICIOUS ACTIVITY

(71) Applicant: Comcast Cable Communications, LLC, Philadelphia, PA (US)

(72) Inventors: Sergey Mironenko, Philadelphia, PA (US); Meishan Cheng, Philadelphia, PA (US)

(21) Appl. No.: 18/455,322

(22) Filed: Aug. 24, 2023

(51) Int. Cl. H04L 9/40

(52) U.S. Cl. CPC H04L 63/1433; H04L 63/205

(57) ABSTRACT

Methods, apparatuses, and systems are described for monitoring a communication network and detecting malware. Network topology data associated with a plurality networks may be used to determine a likelihood that one or more candidate network paths between one or more nodes within the communication network is associated with potential malicious activity. An indication, associated with the potential malicious activity, of the one or more candidate networks may be sent. The indication may be compared with activity data of one or more nodes to determine whether the activity data is associated with malicious activity, and thus, cause one or more remedial actions.

### BACKGROUND

As more devices are being added to communication networks, communication networks have grown in size and complexity. Traffic loss, latency, end-to-end path availability, and suspicious activity are a few examples of network conditions that need to be monitored and tracked in order to provide strong and consistent network access. Due to the increase in size and complexity of communication networks, it is becoming more difficult to detect and determine suspicious behavior patterns within a communication network. Conventional suspicious behavior detection methods rely on binary digital bit streams, patterns in binary code, or patterns of behavior shared by different types of suspicious behaviors. However, if the behavior patterns are too narrowly defined, some types of suspicious behaviors risk not being detected. Furthermore, if the behavior patterns are too broadly defined, non-suspicious types of behaviors may be mistaken for suspicious types of behaviors, which may result in false alarms and potentially corrective action being mistakenly applied.

### SUMMARY

It is to be understood that both the following general description and the following detailed description are examples and explanatory only and are not restrictive. Methods, systems, and apparatuses for monitoring network activity are disclosed.

A network corresponding to one or more devices may be monitored in order to determine potential malicious activity associated with one of more of the devices. Network topology data associated the network may be used to determine a likelihood that one or more candidate network paths between one or more of the devices is associated with potential malicious activity. Activity data of the devices may be compared with the candidate network paths in order to determine whether the activity data of any of the devices are associated with malicious activity. One or more remedial actions may be taken based on determining that the activity data is associated with malicious activity.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for determining malicious activity of a node;

FIG. 2 shows an example communication network with a plurality of candidate network paths;

FIG. 3A-3B show an example comparison of candidate network paths and an actual network path;

FIG. 4 shows an example communication network with a plurality of candidate network paths;

FIG. 5 shows an example machine learning system;

FIG. 6 shows a flowchart of an example machine learning method;

FIG. 7 shows a flowchart of an example method;

FIG. 8 shows a flowchart of an example method;

FIG. 9 shows a flowchart of an example method; and

FIG. 10 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

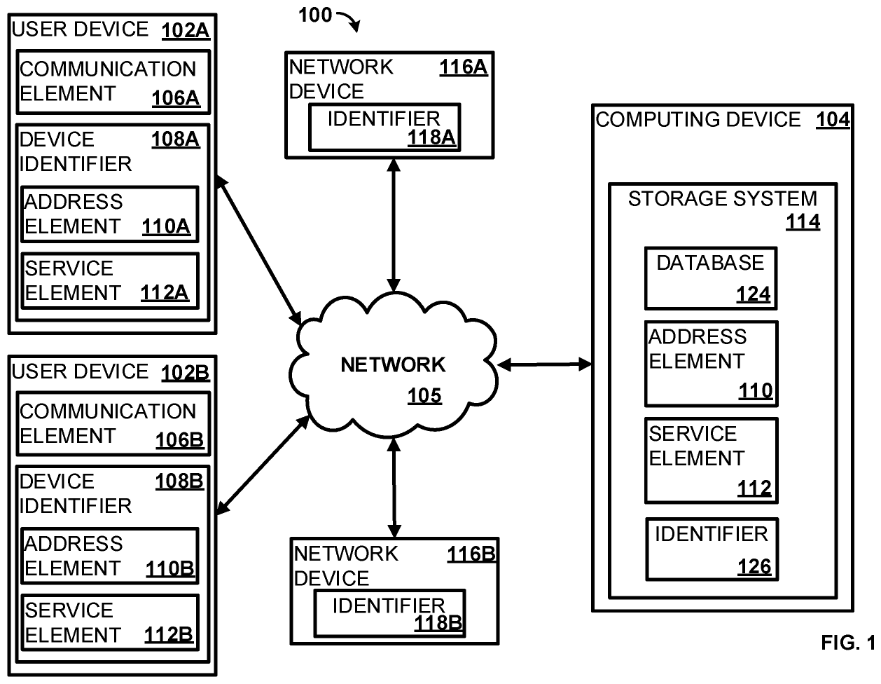

FIG. 1 shows an example system 100 for determining malicious activity within a communication network. For example, the system 100 may be configured to receive network topology data associated with a communication network in order to determine one or more candidate network paths associated with potential malicious activity. The one or more candidate network paths may be compared with activity data of a node (e.g., user device, server, router, etc.) to determine that the activity data of the node is associated with malicious activity. The malicious activity may comprise one or more of a malware attack, accessing a node that is frequently used by a targeted user, and accessing a node containing targeted data/information (e.g., a node containing targeted data such as trade secrets, sensitive information, and/or confidential information). As an example, the malicious activity may be associated with an attempt to gain access to another computer system, network, or computing device that contains a higher level of privileged information or that is associated with a targeted user that may have higher levels of security access. The system 100 may comprise one or more nodes (e.g., a plurality of user devices 102A-102B, a plurality of network devices 116A-116B, etc.) and/or a computing device 104. The nodes (e.g., user devices 102A-102B and/or the network devices 116A-116B) may be in communication with the computing device 104 such as a centralized device or a server, for example. The computing device 104 may be disposed remotely relative to the nodes (e.g., user devices 102A-102B and network devices 116A-116B). As an example, the nodes (e.g., user devices 102A-102B and network devices 116A-116B) and the computing device 104 may be in communication via a private and/or public network 105 such as the Internet or a local area network. Other forms of communications can be used such as wired and wireless telecommunication channels.

The user devices 102A-102B may comprise electronic devices such as a computer, a smartphone, a laptop, a tablet, a set top box, a display device, a printer, a network node, a network device, a communication terminal, a transmitter, or other device capable of communicating with the network devices 116A-116B and/or the computing device 104. As an example, the user devices 102A-102B may comprise communication elements 106A-106B for offering an interface to a user to interact with the user devices 102A-102B and/or the computing device 104. The communication element 106A-106B may be any interface for presenting and/or receiving information to/from the user, such as media content. As an example, the interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the user devices 102A-102B and the network devices 116A-116B. As an example, the communication elements 106A-106B can request or query various files from a local source and/or a remote source. As an example, the communication element 106A-106B can transmit data to a local or remote device such as the network devices 116A-116B or the computing device 104 via the network devices 116A-116B.

The user devices 102A-102B may be associated with user identifiers or device identifiers 108A-108B. As an example, the device identifiers 108A-108B may be any identifier, token, character, string, or the like, for differentiating one user or user device (e.g., a user device 102A) from another user or user device (e.g., a user device 102B). The device identifier 108A-108B may identify a user or user device as belonging to a particular class of users or user devices. As an example, the device identifier 108A-108B may comprise information relating to the user device such as a manufacturer, a model or type of device, a service provider associated with the user device 102A-102B, a state of the user device 102A-102B, a locator, and/or a label or classifier. Other information can be represented by the device identifiers 108A-108B.

The device identifiers 108A-108B may comprise address elements 110A-110B and service elements 112A-112B. The address elements 110A-110B may comprise or make available an internet protocol address, a network address, a media access control (MAC) address, an Internet address, or the like. As an example, the address elements 110A-110B may be relied upon to establish a communication session between the user devices 102A-102B and the network devices 116A-116B or other devices and/or networks. As an example, the address elements 110A-110B may be used as an identifier or locator of the user devices 102A-102B. The address elements 110A-110B may be persistent for a particular network.

The service elements 112A-112B may comprise identification of the service providers associated with the user devices 102A-102B and/or with the class of user devices 102A-102B. The class of the user devices 102A-102B may be related to a type of device, a capability of a device, a type of service being offered, and/or a level of service (e.g., a business class, a service tier, a service package, etc.). As an example, the service elements 112A-112B may comprise information relating to or made available by a communication service provider (e.g., an Internet service provider) that is offering or enabling data flow such as communication services to the user devices 102A-102B. As an example, the service elements 112A-112B may comprise information relating to a preferred service provider for one or more particular services relating to the user devices 102A-102B. The address elements 110A-110B may be used to identify or retrieve data from the service elements 112A-112B, or vice-versa. As an example, one or more of the address elements 110A-110B and the service elements 112A-112B may be stored remotely from the user devices 102A-102B and retrieved by one or more devices such as the user devices 102A-102B and the computing device 104. Other information may be represented by the service element 112A-112B.

A plurality of network devices 116A-116B may be in communication with a network, such as network 105. As an example, one or more of the network devices 116A-116B may be configured to facilitate the connection of a device, such as the user device 102A-102B, to the network 105. As an example, the network devices 116A-116B may be configured as wireless access points (WAPs) or routers. The network devices 116A-116B may be configured to allow one or more wireless devices to connect to a wired and/or wireless network using Wi-Fi, Bluetooth®, Zigbee®, or any desired method or standard.

The network devices 116A-116B may be configured as a local area network (LAN). As an example, the network devices 116A-116B may comprise a dual band wireless access point. As an example, the network devices 116A-116 may be configured with a first service set identifier (SSID) (e.g., associated with a user network or a private network) to function as a local network for a particular user or users. As an example, the network devices 116A-116B may be configured with a second service set identifier (SSID) (e.g., associated with a public/community network or a hidden network) to function as a secondary network or redundant network for connected communication devices.

The network devices 116A-116B may comprise identifiers 118A-118B. As an example, one or more identifiers may be or relate to an Internet Protocol (IP) Address IPV4/IPV6 or a media access control address (MAC address) or the like. As an example, the identifiers 118A-118B may be unique identifiers for facilitating communications on the physical network segment. Each of the network devices 116A-116B may comprise an identifier 118 that is distinct. As an example, the identifiers 118A-118B may be associated with a physical location of the network devices 116A-116B.

The network (e.g., network 105) may include one or more nodes (e.g., user devices 102A-102B, network devices 116A-116B, and the like). Each node (e.g., each device 102A-102B, each network device 116A-116B, etc.) may be associated with activity data. For example, each node may send its activity data to the computing device 104. For example, the activity data may comprise data indicative of one or more actions of a node. For example, the activity data may comprise data indicative of one or more of accessing one or more files stored on the node, accessing another node (e.g., a certain type of node such as a node associated with a higher privileged system that may contain more sensitive, trade secret, or confidential information), accessing personal information, accessing one or more nodes of another network or another enterprise system, etc. In an example, the one or more actions may be associated with the node (e.g., user device 102A-102B, network device 116A-116B, and the like) accessing one or more nodes of the network 105. In an example, each node may implement one or more security measures for protecting each node and the contents stored on each node. The one or more security measures may comprise one or more of a level of encryption, anti-malware software, or a level of firewall service.

The computing device 104 may be a server, or a centralized device, for communicating with the nodes (e.g., network devices 116A-116B, the user devices 102A-102B, etc.) within the network 105. In an example, the computing device 104 may communicate with the user devices 102A-102B for offering data and/or services. For example, the computing device 104 may offer services such as network (e.g., Internet) connectivity, network printing, media management (e.g., a media server), interference management, content services, streaming services, broadband services, or other network-related services.

The computing device 104 may be configured to determine whether activity data of a node (e.g., user devices 102A-102B, network devices 116A-116B, etc.) is associated with malicious activity. For example, one or more nodes (e.g., one or more user devices 102A-102B, one or more network devices 116A-116B, etc.) may be compromised by malware or may be attempting to access another node/network/system. The computing device 104 may be configured to determine one or more candidate network paths within network 105 associated with potential malicious activity. For example, the computing device 104 may determine network topology data associated with a network (e.g., network 105). The network topology data may comprise data indicative of one or more nodes of a network. As an example, the network topology data may comprise data indicative of one or more connections associated with each node of a network (e.g., network 105). As an example, the network topology data may comprise data indicative of one or more connections associated with each node of a plurality of nodes spread throughout multiple networks and/or systems. Each node may comprise one or more of a user device, server, router, and the like. For example, each node may comprise the plurality of user devices 102A-102B, the plurality of network devices 116A-116B, the computing device 104, and the like. The computing device 104 may determine the one or more candidate network paths based on the network topology data. The one or more candidate network paths may comprise at least one node of the one or more nodes of the network (e.g., network 105). In an example, the computing device 104 may be configured to compare the one or more candidate network paths (or an indication of the one or more candidate network paths) with activity data associated with a node (e.g., user device 102A-102B, network device 116A-116B, etc.) in order to determine whether the activity data is associated with malicious activity. The computing device 104 may be configured to cause one or more remedial actions based on a determination that the activity data is associated with malicious activity. The one or more remedial actions may comprise one or more of isolating the malicious activity, deactivating a node, generating an alert, quarantining the malicious activity during an evaluation process of the malicious activity, or disabling an account of a source of the malicious activity (e.g., node, user device 102A-102B, network device 116A-116B, etc.).

As an example, each candidate network path of the one or more candidate paths may be scored based on a quantity of nodes of the at least one node of each candidate network path and a probability associated with each node of each candidate network path. The probability associated with each node may be based on a risk associated with each node. For example, the risk associated with each node may be based on one or more of one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. As an example, the risk may be associated with the ability to gain access to an initial node (e.g., due to a vulnerability of the initial node) in order to gain access to another node/network/system that may contain targeted sensitive, trade secret, or confidential information.

As an example, the computing device 104 may be configured to determine the one or more candidate network paths of a network (e.g., network 105) associated with potential malicious activity based on an application of a predictive model to the network topology data of the network. The predictive model may comprise a machine learning model such as a generative predictive model. The predictive model may be trained based on one or more datasets associated with network topology data associated with a plurality of networks and activity data associated with one or more nodes (e.g., user devices 102A-102B, network devices 116A-116B, etc.). For example, the computing device 104 may receive network topology data associated with the plurality of networks and activity data associated with the one or more nodes. The network topology data may comprise one or more network topology datasets indicative of one or more nodes of the plurality of networks. Each network topology dataset may be indicative of a plurality of connections of each node of each network. The activity data associated with the one or more nodes may comprise a plurality of activity datasets indicative of one or more actions of each node of the one or more nodes accessing at least one node of the one or more nodes. The predictive model may be configured to output an indication associated with potential malicious activity of a network. For example, the indication may be indicative of one or more candidate network paths associated with potential malicious activity of the network.

The computing device 104 may allow the user devices 102A-102B to interact with remote resources such as data, devices, and files. As an example, the computing device 104 may be configured as (or disposed at) a central location (e.g., a headend, or a processing facility), which can receive content (e.g., data, input programming) from multiple sources. In an example, the computing device 104 may be a separate/remote device from the server for determining malicious activity within the communication network (e.g., network 105). The computing device 104 can combine the content from the multiple sources and can distribute the content to user (e.g., subscriber) locations via a distribution system.

The computing device 104 may be configured to manage the communication between the user devices 102A-102B and the network devices 116A-116B and a storage system 114 for sending and receiving data therebetween. As an example, the storage system 114 may store a plurality of files, user identifiers or records, or other information. As an example, the user devices 102A-102B and/or the network devices 116A-116B may request and/or retrieve one or more files from the storage system 114. The storage system 114 may store information relating to the user devices 102A-102B such as the address elements 110A-110B and/or the service elements 112A-112B. As an example, the computing device 104 may obtain the device identifiers 108A-108B and/or 118A-118B from the user devices 102A-102B and/or the network devices 116A-116B and retrieve information from the storage system 114 such as the address elements 110A-110B and/or the service elements 112A-112B. As a further example, the computing device 104 may obtain the address elements 110A-110B from the user devices 102A-102B and/or the network devices 116A-116B and may retrieve the service elements 112A-112B from the storage system 114, or vice versa. The storage system 114 may be integrated with the computing device 104 or some other device or system.

The storage system 114 may comprise a database 124 configured for storing the network topology data, the predictive model, the training data, and/or the activity data associated with the users devices 102A-102B and/or the network devices 116A-116B. Any information can be stored in and retrieved from the storage system 114. As an example, the storage system 114 can be disposed remotely from the computing device 104 and accessed via a direct or an indirect connection. As an example, the storage system 114 can be integrated with the computing device 104 or some other device or system.

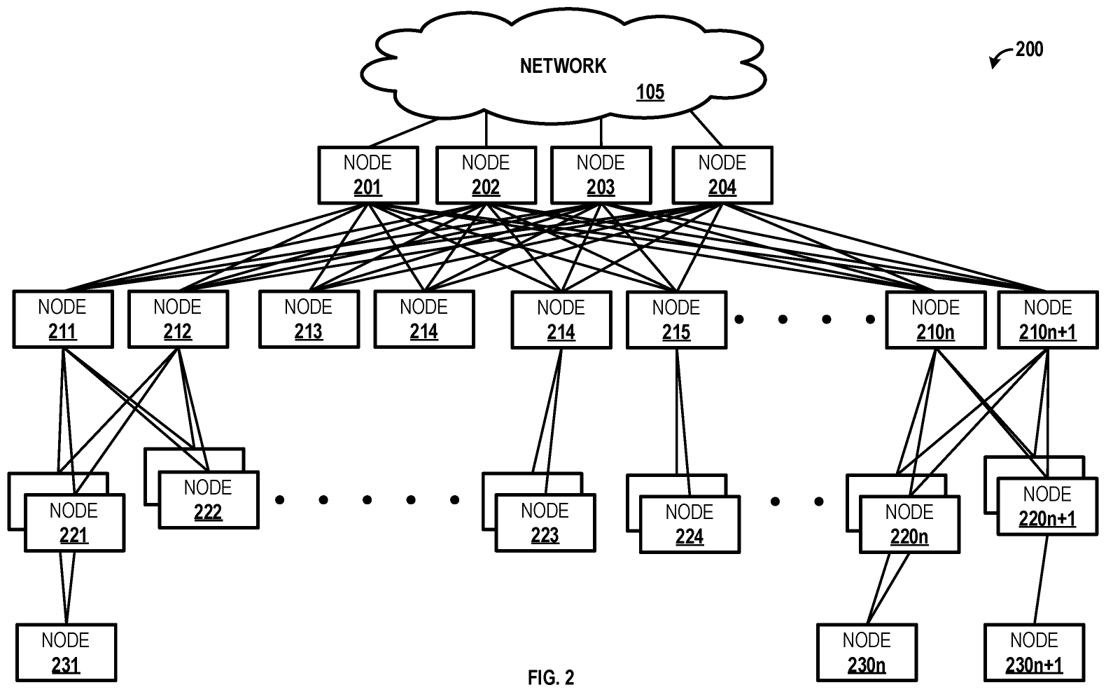

FIG. 2 shows an example communication network comprising a plurality of candidate network paths. For example, a computing device may receive network topology data. The network topology data may comprise data associated with a directory of nodes associated with a network (e.g., network 105) of an entity (e.g., business, organization, etc.). For example, the network topology data may comprise a layout of a plurality of nodes that may make up a network directory of an entity. In an example, the network topology data may include data indicative of the layout of the plurality of nodes across a plurality of networks/systems. The layout may include one or more of connections of each node of the network. The computing device may determine the plurality of candidate network paths based on the network topology data of a network. In an example, the computing device may apply a trained predictive model (e.g., generative predictive model) to the network topology data to determine the plurality of candidate network paths. The plurality of candidate network paths may comprise one or more nodes of the plurality of nodes of the network. Each candidate network path of the plurality of candidate network paths may be associated with potential malicious activity of the network. For example, malicious activity may begin at an initial node (e.g., user device, server, router, etc.) of a network, such as one of the nodes of nodes 201-204, for example. As an example, the malicious activity may comprise one or more of a malware attack, accessing a node that is frequently used by a targeted user, and accessing a node containing targeted data/information. The malicious activity may traverse the network via one or more of the plurality of candidate network paths. For example, the malicious activity may traverse the network from one of the nodes 201-204 to nodes 211-215, 210n+1, from one of the nodes 211-210n+1 to nodes 221-220n+1, and from one of the nodes 221-220n+1 to nodes 231-230n+1. In an example, each candidate network path of the plurality of candidate paths may be scored based on a quantity of nodes of each candidate network path and a probability associated with each node of each candidate network path. The probability associated with each node may be based on a risk associated with each node. For example, the risk associated with each node may be based on one or more of one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. As an example, the risk may be associated with the ability to gain access to an initial node (e.g., due to a vulnerability of the initial node) in order to gain access to another node/network/system that may contain targeted sensitive, trade secret, or confidential information.

In an example, the computing device may receive activity data associated with one or more nodes (e.g., user devices, servers, routers, etc.) of the network, for example. The activity data may comprise data indicative of one or more actions of each node (e.g., user device, server, router, etc.) accessing one or more nodes of the network. For example, the activity data may comprise data indicative of one or more of accessing one or more files stored on the node, accessing another node (e.g., a certain type of node such as a node associated with a higher privileged system that may contain more sensitive, trade secret, or confidential information), accessing personal information, accessing one or more nodes of another network or another enterprise system, etc. The computing device may compare the plurality of candidate network paths with the activity data associated with a node (e.g., user device, server, router, etc.) to determine whether the activity data is associated with malicious activity. The computing device may be configured to cause one or more remedial actions based on a determination that the activity data is associated with malicious activity. The one or more remedial actions may comprise one or more of isolating the malicious activity, deactivating a node, generating an alert, quarantining the malicious activity during an evaluation process of the malicious activity, or disabling an account of a source of the malicious activity.

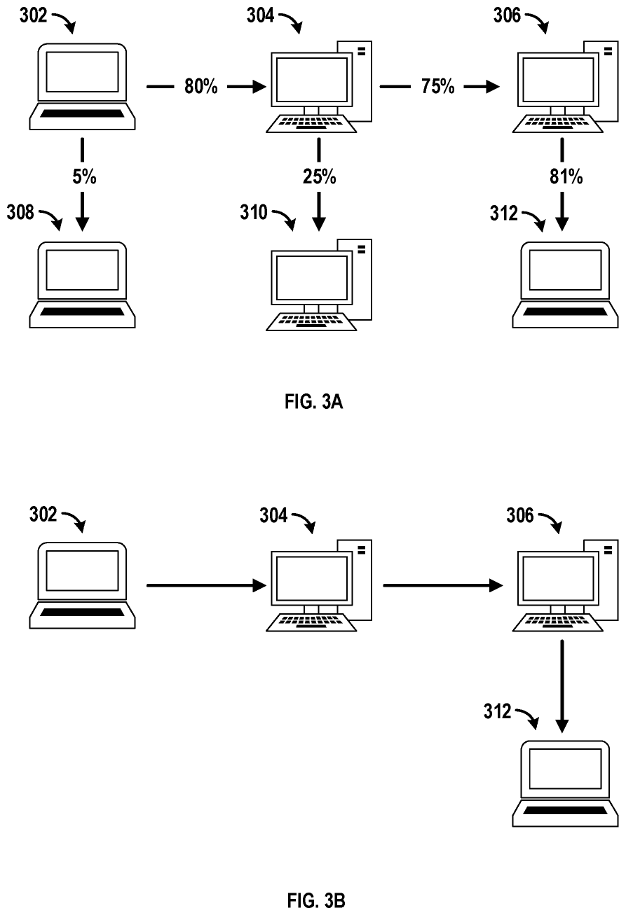

FIGS. 3A-3B show an example comparison of candidate network paths and an actual network path associated with malicious activity. As an example, a computing device may determine one or more candidate network paths based on network topology data of a network. The one or more candidate network paths may comprise one or more nodes (e.g., computing device, user device, server, router, etc.) of a plurality of nodes of the network. FIG. 3A shows several candidate network paths, wherein an initial node 302 may be affected by potential malicious activity. The computing device may score each candidate network path based on the network topology data. For example, each candidate network path may be scored based on a quantity of nodes of each candidate network path and a probability associated with each node of each candidate network path. The probability associated with each node may be based on a risk associated with each node. For example, the risk associated with each node may be based on one or more of one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. As shown in FIG. 3A, a probability that malicious activity may traverse from node 302 to node 308 may comprise a 5% probability. However, a probability that malicious activity may traverse from node 302 to node 304 may comprise an 80% probability. Next, a probably probability that malicious activity may traverse from node 304 to node 310 may comprise a 25% probability. However, a probability that malicious activity may traverse from node 304 to node 306 may comprise a 75% probability. Lastly, a probability that malicious activity may traverse from node 306 to node 312 may comprise an 81% probability. Thus, a candidate network path comprising a traversal from node 302 to node 308 may contain the highest score due to the low probability of malicious activity traversing from node 302 to node 308. Furthermore, a candidate path comprising a traversal from node 302 to node 304 to node 306 to node 312 may contain the lowest score due to a high probability of malicious activity traversing the candidate network path, and thus, the path malicious activity is most likely to traverse. In an example, as shown in FIG. 3B, an actual security event may be compared to the predicted path. As shown in FIG. 3B, the actual network path traversed by malicious activity may match the predicted path with the high probability of malicious activity. As an example, one or more remedial actions may be take based on a determination that an actual network path (e.g., activity data associated with a device associated with the network) matches a predicted, or candidate, network path. For example, the one or more remedial actions may comprise one or more of isolating the malicious activity, deactivating a node, generating an alert, quarantining the malicious activity during an evaluation process of the malicious activity, or disabling an account of a user device.

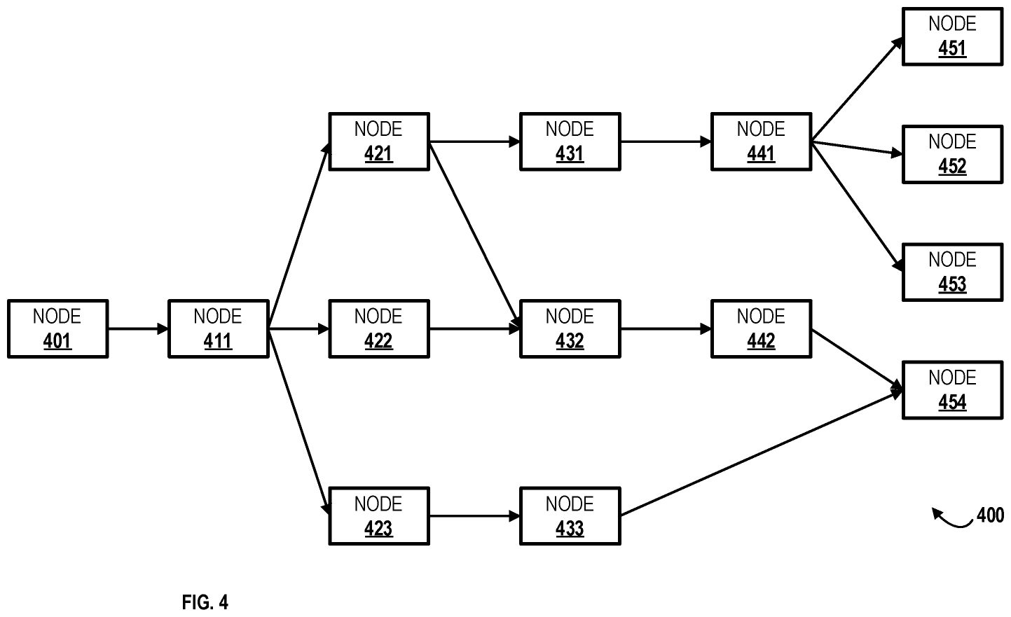

FIG. 4 shows an example communication network comprising a plurality of candidate network paths. As an example, one or more candidate network paths may be determined based on network topology data associated with a network. Each candidate network path may be scored based on a quantity of nodes of each candidate network path and a probability associated with each node of each candidate network path. The probability associated with each node may be based on a risk associated with each node. For example, the risk associated with each node may be based on one or more of one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. In an example, one or more of the most likely candidate network paths may be determined, such as in FIG. 4. The most likely candidate network paths may be determined based on the score, including the probability associated with each node, associated with each candidate network path. As shown in FIG. 4, malicious activity may begin at node 401. The malicious activity may potentially traverse the network via several candidate network paths in order to reach one or more of nodes 451, 452, 453, or 454. In an example, the malicious activity may traverse the network via nodes 411, 421, 431, and 441 in order to reach nodes 451, 452, or 453. In an example, the malicious activity may traverse the network via nodes 411, 421, 432, and 442 in order to reach node 454. In an example, the malicious activity may traverse the network via nodes 411, 422, 432, and 442 in order to reach node 454. In an example, the malicious activity may traverse the network via nodes 411, 423, and 433 order to reach node 454.

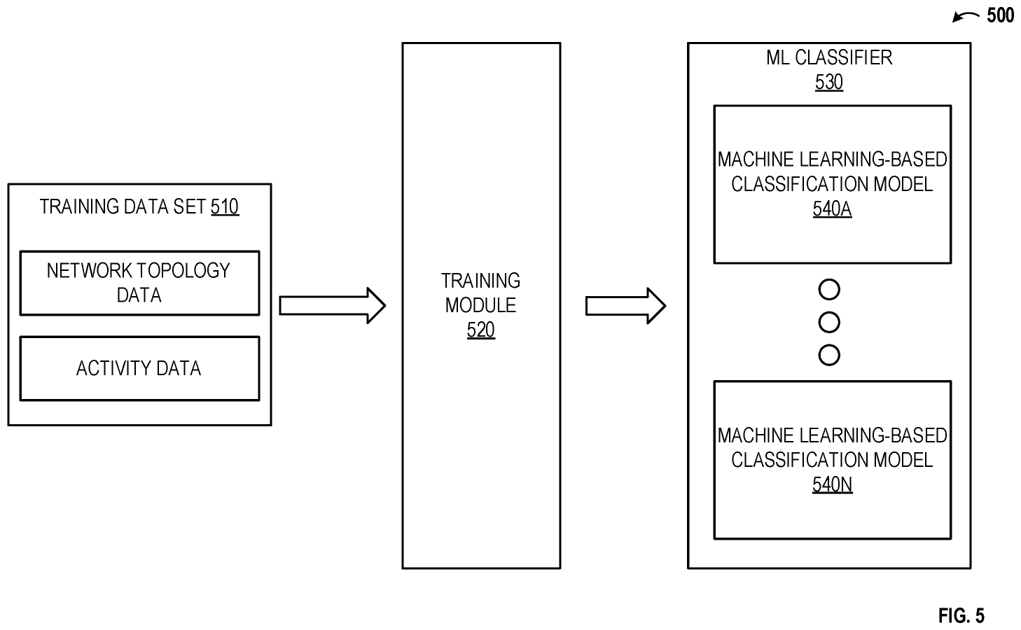

FIG. 5 shows a system 500 that may be configured to use machine learning techniques to train, based on an analysis of one or more training data sets 510 by a training module 520, at least one machine learning-based classifier 530 that is configured to output a prediction of one or more candidate network paths associated with potential malicious activity of a network. As an example, the training data set 510 (e.g., network topology data and activity data) may comprise one or more data sets and/or baseline feature levels. As an example, the one or more training data sets 510 may comprise one or more groups of network topology data and activity data. As an example, the training data set 510 may comprise labeled baseline feature levels (e.g., baseline feature scores). The labels may comprise a plurality of predefined features associated with one or more characteristics associated with the network topology data and the activity data. As an example, the one or more characteristics associated with the network topology data may comprise one or more quantities of nodes of an associated network and a risk associated with each node. As an example, the one or more characteristics associated with the activity data may comprise one or more actions of each node of a plurality of nodes associated with accessing (or traversing) one or more nodes of a plurality of nodes of a network.

The training module 520 may train the machine learning-based classifier 530 by extracting a feature set from the network topology data and the activity data (e.g., one or more training data sets and/or baseline feature levels) in the training data set 510 according to one or more feature selection techniques.

In an example, the training module 520 may extract a feature set from the training data set 510 in a variety of ways. The training module 520 may perform feature extraction multiple times, each time using a different feature-extraction technique. In an example, the feature sets generated using the different techniques may each be used to generate different machine learning-based classification models 540. As an example, the feature set with the highest quality metrics may be selected for use in training. The training module 520 may use the feature set(s) to build one or more machine learning-based classification models 540A-540N that are configured to indicate whether or not new data is associated with one or more candidate network paths associated with potential malicious activity of a network. The one or more candidate network paths may comprise one or more nodes of a plurality of nodes of the network.

In an example, the training data set 510 may be analyzed to determine one or more groups of network topology data and activity data that have at least one feature that may be used to predict the one or more candidate network paths. As an example, the at least one feature may comprise one or more characteristics of network topology data and one or more characteristics of activity data. The one or more groups of network topology data and activity data may be considered as features (or variables) in the machine learning context. The term “feature,” as used herein, may refer to any characteristic of a group of network topology data and activity data that may be used to determine whether the group of network topology data and activity data fall within one or more specific categories.

In an example, a feature selection technique may comprise one or more feature selection rules. The one or more feature selection rules may comprise a network topology characteristic and activity data characteristic occurrence rule. The network topology characteristic and activity data characteristic occurrence rule may comprise determining which network topology characteristics and activity data characteristics or groups of network topology characteristics and activity data characteristics in the training data set 510 occur over a threshold number of times and identifying those network topology characteristics and activity data characteristics that satisfy the threshold as candidate features. For example, any network topology characteristic and activity data characteristic or group of network topology characteristics and activity data characteristics that appear greater than or equal to 50 times in the training data set 510 may be considered as candidate features. Any network topology characteristic and activity data characteristic or group of network topology characteristics and activity data characteristics appearing less than 50 times may be excluded from consideration as a feature.

In an example, the one or more feature selection rules may comprise a significance rule. The significance rule may comprise determining, from the baseline feature level (e.g., baseline feature score) data in the training data set 510, network topology characteristic data and activity characteristic data. The network topology characteristic data may include data associated with a number of nodes comprising one or more networks and a risk associated with each node of each network. The activity characteristic data may include data associated with one or more actions of each node of a plurality of nodes accessing (or traversing) one or more nodes of a plurality of nodes of a network. As the baseline feature level (e.g., baseline feature score) in the training data set 510 are labeled according to one or more candidate network paths, the labels may be used to determine the network topology characteristic data and activity characteristic data.

In an example, a single feature selection rule may be applied to select features or multiple feature selection rules may be applied to select the features. For example, the feature selection rules may be applied in a cascading fashion, with the feature selection rules being applied in a specific order and applied to the results of the previous rule. For example, the network topology characteristic and activity data characteristic occurrence rule may be applied to the training data set 510 to generate a first list of features. The significance rule may be applied to features in the first list of features to determine which features of the first list satisfy the significance rule in the training data set 510 and to generate a final list of candidate features.

The final list of candidate features may be analyzed according to additional feature selection techniques to determine one or more candidate feature signatures (e.g., groups of network topology data and activity data that may be used to predict one or more candidate network paths). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., one or more expected candidate network paths).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 520 has generated a feature set(s), the training module 520 may generate a machine learning-based classification model 540 based on the feature set(s). The machine learning-based classification model 540, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 520 may use the feature sets extracted from the training data set 510 to build a machine learning-based classification model 540A-540N for each classification category (e.g., candidate network path prediction). In an example, the machine learning-based classification models 540A-540N may be combined into a single machine learning-based classification model 540. Similarly, the machine learning-based classifier 530 may represent a single classifier containing a single or a plurality of machine learning-based classification models 540 and/or multiple classifiers containing a single or a plurality of machine learning-based classification models 540.

The extracted features (e.g., one or more candidate features and/or candidate feature signatures derived from the final list of candidate features) may be combined in a classification model trained using a machine learning approach such as: generative predictive machine learning; discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 530 may comprise a decision rule or a mapping that uses the expression levels of the features in the candidate feature signature to predict one or more candidate network paths.

The candidate feature signature and the machine learning-based classifier 530 may be used to provide a prediction indicative of one or more candidate network paths in the testing data set. In an example, the result for each test includes a confidence level that corresponds to a likelihood or a probability that the corresponding test predicted a candidate network path. The confidence level may be a value between zero and one that represents a likelihood that the corresponding test is associated with a candidate network path. In an example, when there are two or more statuses (e.g., two or more expected candidate network paths), the confidence level may correspond to a value p, which refers to a likelihood that a particular test is associated with a first status. In this case, the value 1−p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected candidate network paths for each test. In general, the top performing candidate feature signature will have results that closely match the known one or more candidate network paths.

The top performing candidate feature signature may be used to predict the expected candidate network path. For example, network topology data and activity data and/or baseline feature data may be determined/received. The network topology data and activity data and/or the baseline feature data may be provided to the machine learning-based classifier 530 which may, based on the top performing candidate feature signature, predict/determine an expected candidate network path. The expected candidate network path may be associated with potential malicious activity of a network. In addition, the expected candidate network path comprise one or more nodes (e.g., nodes traversed by malicious activity).

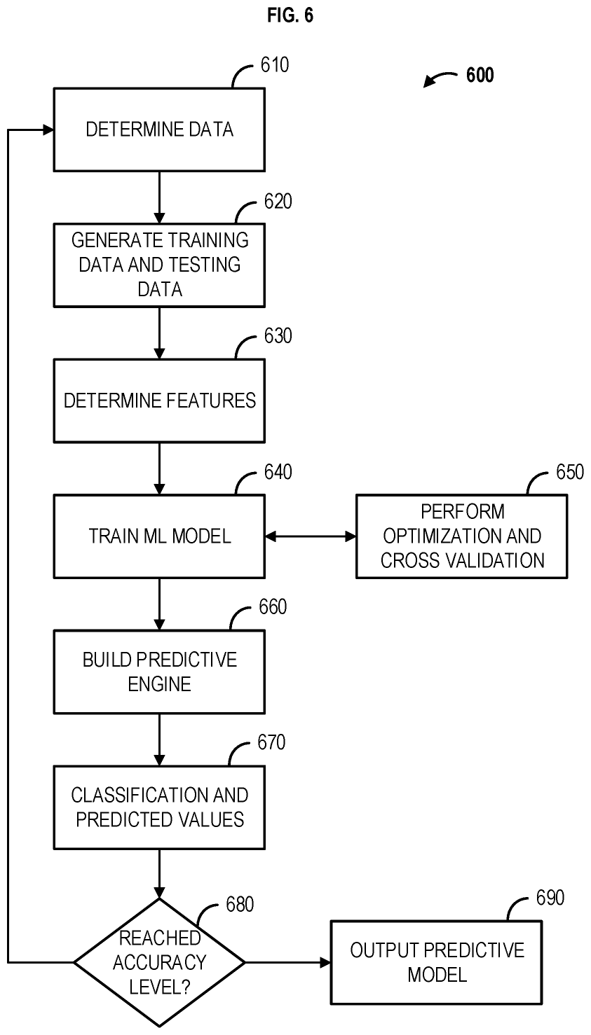

FIG. 6 shows a flowchart of an example training method 600 for generating the machine learning-based classifier 530 using the training module 520. The training module 520 may be implement using supervised, unsupervised, and/or semi-supervised (e.g., reinforcement based) machine learning-based classification models 540. The method 600 shown in FIG. 6 is an example of a supervised learning method; variations of this example of training method are discussed below, however, other training methods may be analogously implemented to train unsupervised and/or semi-supervised machine learning models.

The training method 600 may determine (e.g., access, receive, retrieve, etc.) network topology data and activity data at 610. The network topology data and activity data may contain one or more datasets, wherein each dataset may be associated with one or more groupings of network topology data and activity data. As an example, each dataset may include a labeled list of predetermined features. For example, each dataset may comprise labeled feature data.

The training method 600 may generate, at 620, a training data set and a testing data set. The training data set and the testing data set may be generated by randomly assigning labeled feature data of individual features from the network topology data and the activity data to either the training data set or the testing data set. In an example, the assignment of the labeled feature data of individual features may not be completely random. In an example, only the labeled feature data for a specific grouping of network topology data and activity data may be used to generate the training data set and the testing data set. In an example, a majority of the labeled feature data for the specific grouping of network topology data and activity data may be used to generate the training data set. For example, 75% of the labeled feature data for the specific grouping of network topology data and activity data may be used to generate the training data set and 25% may be used to generate the testing data set. In an example, only the labeled feature data for the specific grouping of network topology data and activity data may be used to generate the training data set and the testing data set.

The training method 600 may determine (e.g., extract, select, etc.), at 630, one or more features that can be used by, for example, a classifier to differentiate among different classifications (e.g., different expected candidate network paths). The one or more features may comprise a group of network topology and activity datasets. In an example, the training method 600 may determine a set of features from the network topology data and the activity data. In an example, a set of features may be determined from network topology data and activity data from a different grouping than the grouping associated with the labeled feature data of the training data set and the testing data set. In other words, the network topology data and the activity data from the different grouping may be used for feature determination, rather than for training a machine learning model. In an example, the training data set may be used in conjunction with the network topology data and the activity data from the different grouping to determine the one or more features. The network topology data and the activity data from the different grouping may be used to determine an initial set of features, which may be further reduced using the training data set.

The training method 600 may train one or more machine learning models using the one or more features at 640. As an example, the machine learning models may be trained using supervised learning. As an example, other machine learning techniques may be employed, including unsupervised learning and semi-supervised. The machine learning models trained at 640 may be selected based on different criteria depending on the problem to be solved and/or data available in the training data set. For example, machine learning classifiers can suffer from different degrees of bias. Accordingly, more than one machine learning model may be trained at 640, optimized, improved, and cross-validated at 650.

The training method 600 may select one or more machine learning models to build a predictive model at 660 (e.g., a machine learning classifier). The predictive model may be evaluated using the testing data set. The predictive model may analyze the testing data set and generate classification values and/or predicted values at 670. Classification and/or prediction values may be evaluated at 680 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly predicted a candidate network path based on the network topology data and the activity data. Conversely, the false negatives of the predictive model may refer to a number of times the machine learning model determined that one or more candidate network paths were not associated with one or more groupings of network topology data and activity data when, in fact, the one or more groupings of network topology data and activity data were associated with the one or more candidate network paths. True negatives and true positives may refer to a number of times the predictive model correctly classified one or more candidate network paths of a network based on the network topology data and the activity data. Related to these measurements are the concepts of recall and precision. Generally, recall refers to a ratio of true positives to a sum of true positives and false negatives, which quantifies a sensitivity of the predictive model. Similarly, precision refers to a ratio of true positives to a sum of true and false positives.

When a desired accuracy level is reached, the training phase ends and the predictive model may be output at 690; when the desired accuracy level is not reached, however, then a subsequent iteration of the training method 600 may be performed starting at 610 with variations such as, for example, considering a larger collection of network topology data and activity data.

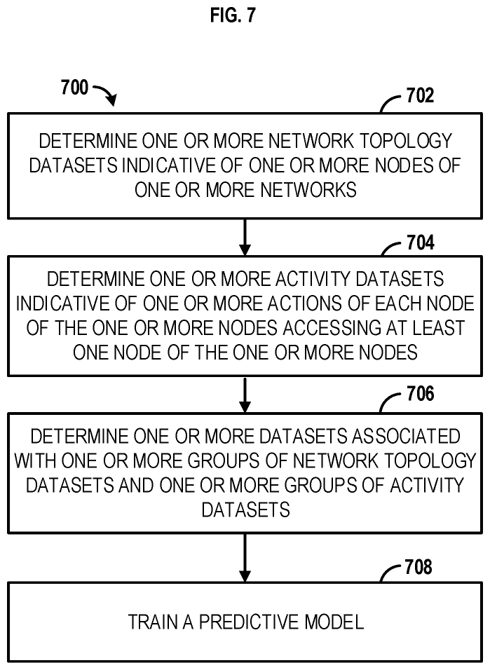

FIG. 7 shows a flowchart of an example method 700. Method 700 may be implemented, for example, by a computing device (e.g., computing device 104, server, headend, router, and the like). At step 702, one or more network topology datasets indicative of one or more nodes of one or more networks may be determined. For example, the one or more network topology datasets may be determined by a computing device. In an example, the one or more network topology datasets may be received from a directory maintained by an entity (e.g., business, organization, public data source entity, etc.). Each network topology dataset may be indicative of one or more connections of each node of each network. As an example, the one or more network topology datasets may comprise data indicative of one or more connections associated with each node of a plurality of nodes spread throughout multiple networks and/or systems. Each node may comprise one or more of a user device, a server, or a router.

At step 704, one or more activity datasets indicative of one or more actions of each node of the one or more nodes accessing at least one node of the one or more nodes may be determined. For example, the one or more activity datasets may be determined by the computing device. In an example, the one or more activity datasets may be received from a directory maintained by an entity (e.g., business, organization, public data source entity, etc.). In an example, the activity data may comprise data indicative of one or more of accessing one or more files stored on the node, accessing another node (e.g., a certain type of node such as a node associated with a higher privileged system that may contain more sensitive, trade secret, or confidential information), accessing personal information, accessing one or more nodes of another network or another enterprise system, etc.

At step 706, one or more data sets may be determined based on the one or more network topology datasets and the one or more activity datasets. For example, the one or more data sets may be determined by the computing device based on the one or more network topology datasets and the one or more activity datasets. Each dataset may be associated with one or more groups of network topology datasets and one or more groups of activity datasets. In an example, each group of network topology datasets may be associated with data indicative of a quantity of nodes associated with each network of the plurality of networks and a risk associated with each node of each network. The risk associated with each node may be based on one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. In an example, each group of activity datasets may be associated with one or more actions associated with one or more nodes of the plurality of nodes.

At step 708, a predictive model may be trained based on the one or more datasets. For example, the predictive model may be trained by the computing device based on the one or more datasets. The predictive model may be configured (e.g., based on the training) to output an indication that is associated with potential malicious activity of a network. For example, the indication may be indicative of one or more candidate network paths associated with the potential malicious activity. The one or more candidate network paths may comprise at least one node of one or more nodes of the network. For example, the malicious activity may be associated with, or comprise, a malware attack, accessing a node that is frequently used by a targeted user, and accessing a node containing targeted data/information. Each candidate network path may be associated with the malicious activity's traversal via at least one node of one or more nodes of a network. Each candidate network path of the one or more candidate network paths may be scored based on a quantity of nodes of the at least one node of each candidate network path and a probability associated with each node of each candidate network path. The probability may be based on a risk associated with each node. The risk associated with each node may be based on one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. As an example, the risk may be associated with the ability to gain access to an initial node (e.g., due to a vulnerability of the initial node) in order to gain access to another node/network/system that may contain targeted sensitive, trade secret, or confidential information.

In an example, network topology data associated with a specific network may be received. For example, the computing device may receive the network topology data associated with the specific network. A likelihood of one or more candidate network paths being associated with potential malicious activity of the network may be determined based on an application of the predictive model to the network topology data associated with the network. An indication, associated with the potential malicious activity, of the one or more candidate network paths of the network may be sent. For example, a first computing device monitoring the network may send the indication to a second computing device that may compare the one or more candidate network paths to activity data associated with a specific node (e.g., user device, server, router, etc.) to determine whether the activity data of the specific node is associated with malicious activity.

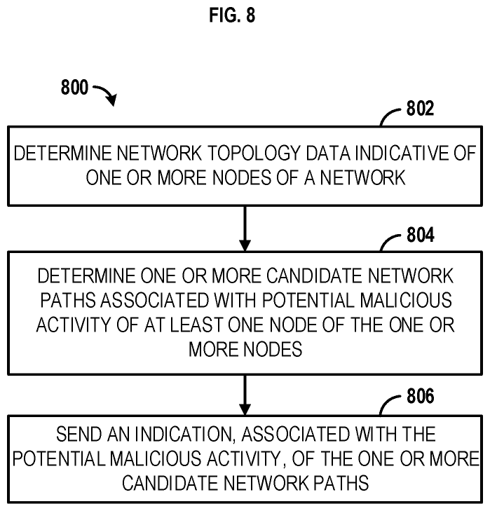

FIG. 8 shows a flowchart of an example method 800. Method 800 may be implemented, for example, by a computing device (e.g., computing device 104, server, headend, router, and the like). At step 802, network topology data indicative of one or more nodes of a network may be determined. For example, a computing device may determine the network topology data. In an example, the network topology data may further comprise data indicative of one or more connections associated with each node of the network. Each node of the one or more nodes may comprise one or more of a user device, a server, or a router.

At step 804, one or more candidate network paths associated with potential malicious activity of at least one node of the one or more nodes may be determined based on the network topology data. For example, the one or more candidate network paths associated with potential malicious activity may be determined by the computing device based on the network topology data. The malicious activity may comprise one or more of a malware attack, accessing a node that is frequently used by a targeted user, and accessing a node containing targeted data/information. In an example, the one or more candidate paths associated with potential malicious activity may be determined based on an application of a predictive model to the network topology data. The predictive model may be trained based on one or more network topology datasets associated with one or more networks and one or more activity datasets associated with one or more nodes. Each candidate network path of the one or more candidate network paths may be scored based on a quantity of nodes of the at least one node of each candidate network path and a probability associated with each node of each candidate network path. The probability may be based on a risk associated with each node. The risk associated with each node may be based on one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. As an example, the risk may be associated with the ability to gain access to an initial node (e.g., due to a vulnerability of the initial node) in order to gain access to another node/network/system that may contain targeted sensitive, trade secret, or confidential information.

At step 806, an indication associated with the potential malicious activity may be sent. For example, the indication may be sent by the computing device. In an example, the indication may be indicative of the one or more candidate network paths. In an example, the indication may be used to compare the one or more candidate network paths associated with the potential malicious activity associated with activity data of a node. For example, it may be determined that the activity data of the node is associated with malicious activity based on a comparison of the indication with activity data of a node. As an example, the activity data may comprise data indicative of one or more actions of the node accessing at least one node of the one or more nodes. As an example, the activity data may comprise data indicative of one or more of accessing one or more files stored on the node, accessing another node (e.g., a certain type of node such as a node associated with a higher privileged system that may contain more sensitive, trade secret, or confidential information), accessing personal information, accessing one or more nodes of another network or another enterprise system, etc. In an example, one or more remedial actions may be implemented (or caused) based on the activity data being associated with malicious activity. The one or more remedial actions may comprise one or more of isolating the malicious activity, deactivating a node, generating an alert, quarantining the malicious activity during an evaluation process of the malicious activity, or disabling an account of the user device.

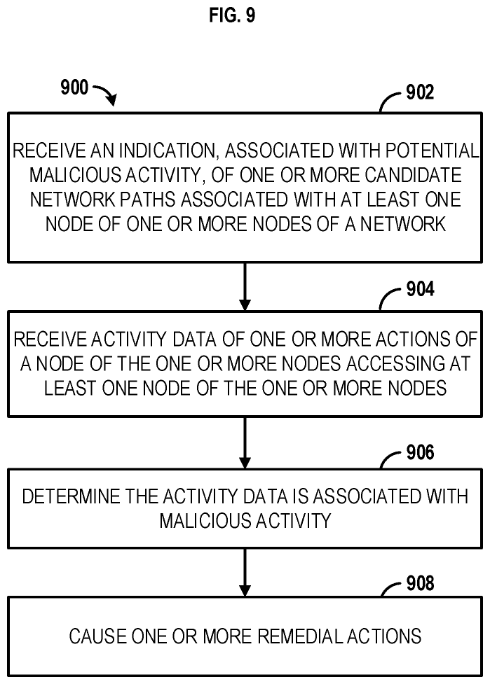

FIG. 9 shows a flowchart of an example method 900. Method 900 may be implemented, for example, by a computing device (e.g., computing device 104, server, headend, router, and the like). At step 902, an indication associated with potential malicious activity of a network may be received. For example, a computing device may receive the indication associated with the potential malicious activity of the network. As an example, the indication may be indicative of one or more candidate network paths associated with the potential malicious activity. The one or more candidate network paths may comprise at least one node of one or more nodes of the network (e.g., one or more potential nodes traversed by the potential malicious activity). Each candidate network path of the one or more candidate network paths may be scored based on a quantity of nodes of the at least one node of each candidate network path and a probability associated with each node of each candidate network path. The probability may be based on a risk associated with each node. The risk associated with each node may be based on one or more of one or more security measures implemented by each node, the node being frequently used by a targeted user, the node containing targeted data/information, and the node being associated with a connection to another network/system (e.g., network/system that contains targeted data/information). The one or more security measures may comprise one or more of a level of encryption, anti-malware software, or a level of firewall service. Each node of the plurality of nodes may comprise one or more of a user device, a server, or a router. The malicious activity may comprise one or more of a malware attack, accessing a node that is frequently used by a targeted user, and accessing a node containing targeted data/information.

At step 904, activity data indicative of one or more actions of a node of the one or more nodes accessing at least one node of the one or more nodes may be received. For example, the activity data may be received by the computing device. As an example, the activity data may comprise data indicative of one or more of accessing one or more files stored on the node, accessing another node (e.g., a certain type of node such as a node associated with a higher privileged system that may contain more sensitive, trade secret, or confidential information), accessing personal information, accessing one or more nodes of another network or another enterprise system, etc.

At step 906, it may be determined that the activity data is associated with malicious activity based on a comparison of the indication and the activity data. For example, the computing device may determine that the activity data is associated with malicious activity based on the comparison of the indication and the activity data.

At step 908, one or more remedial actions may be caused (e.g., implemented) based on the activity data being associated with malicious activity. For example, the one or more remedial actions may be caused (e.g., implemented) by the computing device based on the activity data being associated with malicious activity. The one or more remedial actions may comprise one or more of isolating the malicious activity, deactivating a node, generating an alert, quarantining the malicious activity during an evaluation process of the malicious activity, or disabling an account of the user device. In an example, a predictive model may be updated based on the one or more candidate network paths and the activity data being associated with malicious activity.

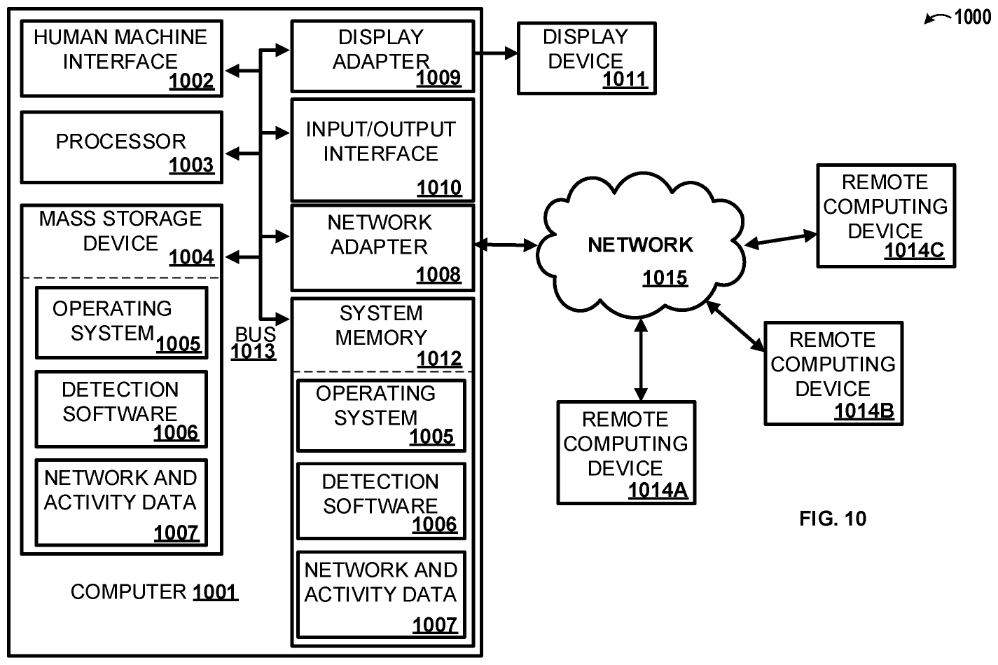

FIG. 10 shows a block diagram illustrating an example computing device. The methods and systems can be implemented on a computer 1001 as shown in FIG. 10 and described below. By way of example, user device 102 and computing device 104 of FIG. 1 can be a computer 1001 as illustrated in FIG. 10. Similarly, the methods and systems disclosed can utilize one or more computers to perform one or more functions in one or more locations. FIG. 10 is a block diagram illustrating an exemplary operating environment 1000 for performing the disclosed methods. This exemplary operating environment 1000 is only an example of an operating environment and is not intended to suggest any limitation as to the scope of use or functionality of operating environment architecture. Neither should the operating environment 800 be interpreted as having any dependency or requirement relating to any one or combination of components illustrated in the exemplary operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 including the one or more processors 1003 to the system memory 1012. In the case of multiple processors 1003, the system can utilize parallel computing.

The bus 1013 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, detection software 1006, network and activity data 1007, a network adapter 1008, system memory 1012, an Input/Output Interface 1010, a display adapter 1009, a display device 1011, and a human machine interface 1002, can be contained within one or more remote computing devices 1014A-1014C at physically separate locations, connected through buses of this form, in effect implementing a fully distributed system.

The computer 1001 typically comprises a variety of computer readable media. Exemplary readable media can be any available media that is accessible by the computer 1001 and comprises, for example and not meant to be limiting, both volatile and non-volatile media, removable and non-removable media. The system memory 1012 can comprise computer readable media in the form of volatile memory, such as random access memory (RAM), and/or non-volatile memory, such as read only memory (ROM). The system memory 1012 typically can comprise data such as network and activity data 1007 and/or program modules such as operating system 1005 and detection software 1006 that are accessible to and/or are operated on by the one or more processors 1003.

The computer 1001 can also comprise other removable/non-removable, volatile/non-volatile computer storage media. By way of example, the computer 1001 can comprise a mass storage device 1004 which can offer non-volatile storage of computer code, computer readable instructions, data structures, program modules, and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, an operating system 1005 and detection software 1006. One or more of the operating system 1005 and detection software 1006 (or some combination thereof) can comprise elements of the programming and the detection software 1006. Network and activity data 1007 can also be stored on the mass storage device 1004. Network and activity data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

The user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via a human machine interface 1002 that is coupled to the bus 1013, but can be connected by other interface and bus structures, such as a parallel port, game port, an IEEE 1394 Port (also known as a Firewire port), a serial port, network adapter 1008, and/or a universal serial bus (USB).

A display device 1011 can also be connected to the bus 1013 via an interface, such as a display adapter 1009. It is contemplated that the computer 1001 can have more than one display adapter 1009 and the computer 1001 can have more than one display device 1011. For example, a display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via Input/Output Interface 1010. Any step and/or result of the methods can be output in any form to an output device. Such output can be any form of visual representation, including, but not limited to, textual, graphical, animation, audio, tactile, and the like. The display 811 and computer 1001 can be part of one device, or separate devices.

The computer 1001 can operate in a networked environment using logical connections to one or more remote computing devices 1014A, 1014B, and 1014C. By way of example, a remote computing device 1014A-1014C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1001 and a remote computing device 1014A-1014C can be made via a network 1015, such as a local area network (LAN) and/or a general wide area network (WAN). Such network connections can be through a network adapter 1008. A network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components can reside at various times in different storage components of the computer 1001, and are executed by the one or more processors 1003 of the computer 1001. An implementation of detection software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, one or more network topology datasets indicative of one or more nodes of one or more networks;
determining one or more activity datasets indicative of one or more actions of each node of the one or more nodes accessing at least one node of the one or more nodes;
determining, based on the one or more network topology datasets and the one or more activity datasets, one or more datasets associated with one or more groups of network topology datasets and one or more groups of activity datasets; and
training, based on the one or more datasets, a predictive model.

2. The method of claim 1, wherein each network topology dataset of the one or more network topology datasets is further indicative of one or more connections of each node of each network.

3. The method of claim 1, wherein each node of the one or more nodes comprises one or more of a user device, a server, or a router.

4. The method of claim 1, wherein the predictive model is configured to output an indication, associated with potential malicious activity, of one or more candidate network paths associated with at least one node of one or more nodes of a network.

5. The method of claim 4, wherein each candidate network path of the one or more candidate network paths is scored based on a quantity of nodes of the at least one node of each candidate network path and a probability associated with each node of each candidate network path.

6. The method of claim 5, wherein the probability is based on a risk associated with each node, wherein the risk associated with each node is based on one or more of one or more security measures implemented by each node, the node being frequently used by a targeted user, the node containing targeted information, or the node being associated with a connection to another network or system.

7. The method of claim 1, further comprising:
receiving network topology data associated with a network;
determining, based on an application of the predictive model to the network topology data associated with the network, a likelihood of one or more candidate network paths being associated with potential malicious activity of the network; and
sending an indication, associated with the potential malicious activity, of the one or more candidate network paths.

8. A method comprising:
determining, by a computing device, network topology data indicative of one or more nodes of a network;
determining, based on the network topology data, one or more candidate network paths associated with potential malicious activity of at least one node of the one or more nodes; and
sending an indication, associated with the potential malicious activity, of the one or more candidate network paths.

9. The method of claim 8, wherein the network topology data is further indicative of one or more connections of each node of the network.

10. The method of claim 8, wherein each node of the one or more nodes comprises one or more of a user device, a server, or a router.

11. The method of claim 8, wherein determining, based on the network topology data, the one or more candidate network paths associated with potential malicious activity comprises determining, based on an application of a predictive model to the network topology data, a likelihood of the one or more candidate network paths being associated with potential malicious activity.

12. The method of claim 8, wherein each candidate network path of the one or more candidate network paths is scored based on a quantity of nodes of the at least one node of each candidate network path and a probability associated with each node of each candidate network path.

13. The method of claim 12, wherein the probability is based on a risk associated with each node, wherein the risk associated with each node is based on one or more of one or more security measures implemented by each node, the node being frequently used by a targeted user, the node containing targeted information, or the node being associated with a connection to another network or system.

14. The method of claim 8, further comprising determining, based on a comparison of the indication and activity data of a node, the activity data is associated with malicious activity, wherein the activity data is indicative of one or more actions of the node accessing at least one node of the one or more nodes of the network.

15. The method of claim 14, further comprising causing one or more remedial actions based on the activity data being associated with malicious activity, wherein the one or more remedial actions comprise one or more of isolating the malicious activity, deactivating a node, generating an alert, quarantining the malicious activity during an evaluation process of the malicious activity, or disabling an account of a user device.

16. A method comprising:
receiving, by a computing device, an indication, associated with potential malicious activity, of one or more candidate network paths associated with at least one node of one or more nodes of a network;
receiving activity data indicative of one or more actions of a node of the one or more nodes accessing at least one node of the one or more nodes;
determining, based on a comparison of the indication and the activity data, the activity data is associated with malicious activity; and
causing, based on the activity data being associated with malicious activity, one or more remedial actions.

17. The method of claim 16, wherein each candidate network path of the one or more candidate network paths is scored based on a quantity of nodes of the at least one node of each candidate network path and a probability associated with each node of each candidate network path.

18. The method of claim 16, wherein each node of the one or more nodes comprises one or more of a user device, a server, or a router.

19. The method of claim 16, further comprising updating a predictive model based on the one or more candidate network paths and based on the activity data being associated with malicious activity.

20. The method of claim 16, wherein the one or more remedial actions comprise one or more of isolating the malicious activity, deactivating a node, generating an alert, quarantining the malicious activity during an evaluation process of the malicious activity, or disabling an account of a user device.
